(19) United States
(12) Patent Application Publication
(10) Pub. No.: US 2012/0182918 A1
(43) Pub. Date: Jul. 19, 2012

(54) Method of Handling Latency Impact on CoMP HARQ and Feedback Operation and Related Communication Device

(76) Inventor: Yu-Chih Jen, Taoyuan County (TW)

(21) Appl. No.: 13/351,244

(22) Filed: Jan. 17, 2012

Related U.S. Application Data
(60) Provisional application No. 61/433,277, filed on Jan. 17, 2011.

(51) Int. Cl. H04W 4/06; H04W 72/04

(52) U.S. Cl. 370/312

(57) ABSTRACT

A method of handling a hybrid automatic repeat request (HARQ) operation for a network in a wireless communication system is disclosed. The network supports a coordinated multipoint transmission/reception (CoMP) operation. The method comprises determining a modified HARQ operation for the CoMP operation, wherein the modified HARQ operation is a derived HARQ operation or a variation of the HARQ operation; configuring the modified HARQ operation to a mobile device in the wireless communication system when the mobile device participates in the CoMP operation; and performing a transmission or a reception of a HARQ process according to the modified HARQ operation.

### CROSS REFERENCE TO RELATED APPLICATIONS

This application claims the benefit of U.S. Provisional Application No. 61/433,277, filed on Jan. 17, 2011 and entitled “Method and Apparatus to Mitigate Latency Impact on CoMP HARQ and Feedback Operation”, the contents of which are incorporated herein in their entirety.

### BACKGROUND OF THE INVENTION

1. Field of the Invention

The present invention relates to a method used in a wireless communication system and related communication device, and more particularly, to a method of handling latency impact on CoMP HARQ and feedback operation and related communication device.

2. Description of the Prior Art

A long-term evolution (LTE) system supporting the 3GPP Rel-8 standard and/or the 3GPP Rel-9 standard are developed by the 3rd Generation Partnership Project (3GPP) as a successor of a universal mobile telecommunications system (UMTS), for further enhancing performance of the UMTS to satisfy increasing needs of users. The LTE system includes a new radio interface and a new radio network architecture that provides a high data rate, low latency, packet optimization, and improved system capacity and coverage. In the LTE system, a radio access network known as an evolved universal terrestrial radio access network (E-UTRAN) includes multiple evolved Node-Bs (eNBs) for communicating with multiple UEs, and communicates with a core network including a mobility management entity (MME), a serving gateway, etc., for Non Access Stratum (NAS) control.

A LTE-advanced (LTE-A) system, as its name implies, is an evolution of the LTE system. The LTE-A system targets faster switching between power states, improves performance at the coverage edge of an eNB, and includes advanced techniques, such as carrier aggregation (CA), coordinated multipoint transmission/reception (CoMP), UL multiple-input multiple-output (MIMO), etc. For a UE and an eNB to communicate with each other in the LTE-A system, the UE and the eNB must support standards developed for the LTE-A system, such as the 3GPP Rel-10 standard or later versions.

When the CoMP is configured to a UE and multiple cells (e.g. cooperating network points), the UE may communicate with the cells simultaneously, i.e., access a service via all or part of the cells. More specifically, an eNB may manage only one cell, or may manage multiple cells (e.g. via remote radio head (RRH)). That is, Cell IDs of different cells may be different (e.g. when being managed by different eNBs or the same eNB), or may be the same (e.g. when being managed by different eNBs or the same eNB). Thus, signals transmitted between the UE and the cells can be easily recovered due to better quality of the signals. In detail, the cells involved in the CoMP can be denoted as cooperating cells, wherein one of the cooperating cells is a serving cell. In general, link quality between the serving cell and the UE is better than those between other cooperating cells and the UE. Control information required for the CoMP is usually transmitted by the UE to the serving cell first. Then, the serving cell exchanges the control information with other cooperating cells such that the CoMP can operate regularly. Further, the CoMP can be classified into two main categories: Joint Processing (JP) and Coordinated Scheduling/Beamforming (CS/CB). A main difference between the JP and the CS/CB is that data of the UE is available at all the cooperating cells when the JP is configured (i.e. enabled), while the data of the UE is only available at the serving cell when the CS/CB is configured. The JP can be further divided into two categories: joint transmission and dynamic cell selection. When the joint transmission is configured, the data of the UE can be transmitted from multiple cooperating cells (e.g. coherently or noncoherently) to the UE to improve signal quality and/or cancel interferences. When the dynamic cell selection is configured, the data of the UE is transmitted from only one of the cooperating cells (e.g. according to a choice or suggestion of the UE) to the UE to improve signal quality and/or avoid the interferences. On other hand, when the CS/CB is configured, the data of the US is only transmitted from the serving cell to the UE, while other cooperating cells may stop transmissions or adjust beamforming to mitigate the interferences.

A hybrid automatic repeat request (HARQ) process is used in the LTE system and the LTE-A system to provide both efficient and reliable data transmissions. Different from an ARQ process, an error correction code (ECC) (e.g. a convolutional code) is used in the HARQ process. For example, a receiver (e.g. a UE) feeds back an acknowledgment (ACK) to inform a transmitter (e.g. a cell) that a packet has been received correctly if the receiver decodes the packet correctly. Oppositely, the receiver feeds back a negative acknowledgment (NACK) to the transmitter if the receiver cannot decode the packet correctly. In this situation, the receiver stores part or all of the packet in a soft buffer of the receiver. After the receiver receives a retransmitted packet from the transmitter, the receiver decodes the part or all of the packet and the retransmitted packet jointly. The receiver continues the HARQ process until the packet is decoded correctly. Since the packet with the small errors can be correctly decoded by using the ECC without feeding back the NACK, i.e., requesting a retransmission, throughput of the communication system is increased due to fewer retransmissions.

However, when the HARQ process is performed, the CoMP may not operate regularly due to a coordination latency. In detail, after a serving cell receives control information from a UE, the serving cell and other cooperating cells need to exchange necessary information (e.g. data, coordinated control information, scheduling and/or resource allocation) such that the CoMP can operate regularly. However, the HARQ process (e.g. transmissions or receptions) is performed according to a round-trip time (RTT) defined in the 3GPP standard, and the RTT may not be sufficient for exchanging the necessary information. In other words, the cooperating cells may need to perform the HARQ process, before the necessary information is completely exchanged. More specifically, the CoMP may operate by using the control information which is wrong, expired or incomplete, and performance of the CoMP is degraded. Therefore, how to solve the problem of the coordination latency is a topic to be discussed and addressed.

### SUMMARY OF THE INVENTION

The present invention therefore provides a method and related communication device for handling latency impact on CoMP HARQ and feedback operation to solve the abovementioned problems.

A method of handling a hybrid automatic repeat request (HARQ) operation for a network in a wireless communication system is disclosed. The network supports a coordinated multipoint transmission/reception (CoMP) operation. The method comprises determining a modified HARQ operation for the CoMP operation, wherein the modified HARQ operation is a derived HARQ operation or a variation of the HARQ operation; configuring the modified HARQ operation to a mobile device in the wireless communication system when the mobile device participates in the CoMP operation; and performing a transmission or a reception of a HARQ process according to the modified HARQ operation.

A method of handling a hybrid automatic repeat request (HARQ) operation for a mobile device in a wireless communication system is disclosed. The mobile device supports a coordinated multipoint transmission/reception (CoMP) operation. The method comprises being configured with a modified HARQ operation for the CoMP operation by a network in the wireless communication system, when the mobile device participates in the CoMP operation, wherein the modified HARQ operation is a derived HARQ operation or a variation of the HARQ operation; and performing a transmission or a reception of a HARQ process according to the modified HARQ operation.

A method of handling a coordinated multipoint transmission/reception (CoMP) operation for a network of a wireless communication system is disclosed. The network supports the CoMP operation. The method comprises determining at least one of at least one transmission mode and modulation and coding scheme (MCS) of the CoMP operation for successive transmissions or receptions corresponding to the HARQ operation; and performing the transmissions or the receptions corresponding to the HARQ operation to or from a mobile device in the wireless communication system according to the at least one of the at least one transmission mode and MCS.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a schematic diagram of communication protocol layers for an exemplary wireless communication system.

FIG. 4 is a flowchart of an exemplary process according to the present invention.

FIG. 5 is a flowchart of an exemplary process according to the present invention.

### DETAILED DESCRIPTION

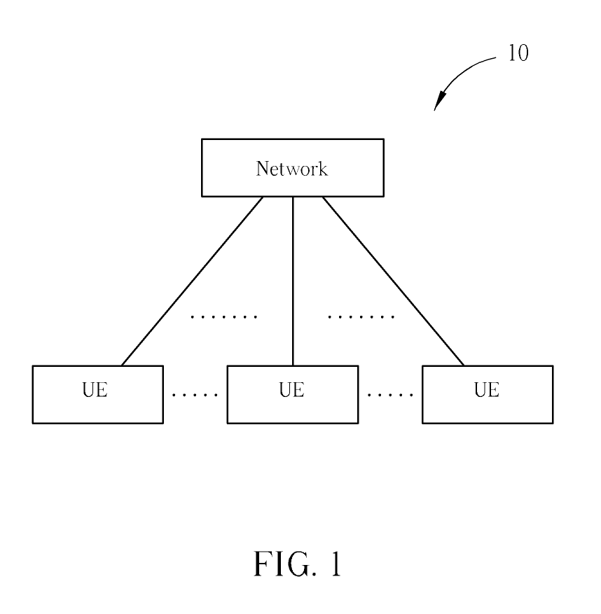

Please refer to FIG. 1, which is a schematic diagram of a wireless communication system 10 according to an example of the present invention. The wireless communication system 10 is briefly composed of a network and a plurality of user equipments (UEs), wherein the network and the UEs support coordinated multipoint transmission/reception (CoMP). In FIG. 1, the network and the UEs are simply utilized for illustrating the structure of the wireless communication system 10. Practically, the network can be an evolved universal terrestrial radio access network (E-UTRAN) comprising a plurality of evolved Node-Bs (eNBs) and relays in a long term evolution-advanced (LTE-A) system, and is not limited herein. Further, each of the plurality of eNBs can manage one or more cells (e.g. cooperating cells), and a relay may also be a cooperating cell. The UEs can be mobile devices such as mobile phones, laptops, tablet computers, electronic books, and portable computer systems. Besides, the network and a UE can be seen as a transmitter or a receiver according to transmission direction, e.g., for an uplink (UL), the UE is the transmitter and the network is the receiver, and for a downlink (DL), the network is the transmitter and the UE is the receiver.

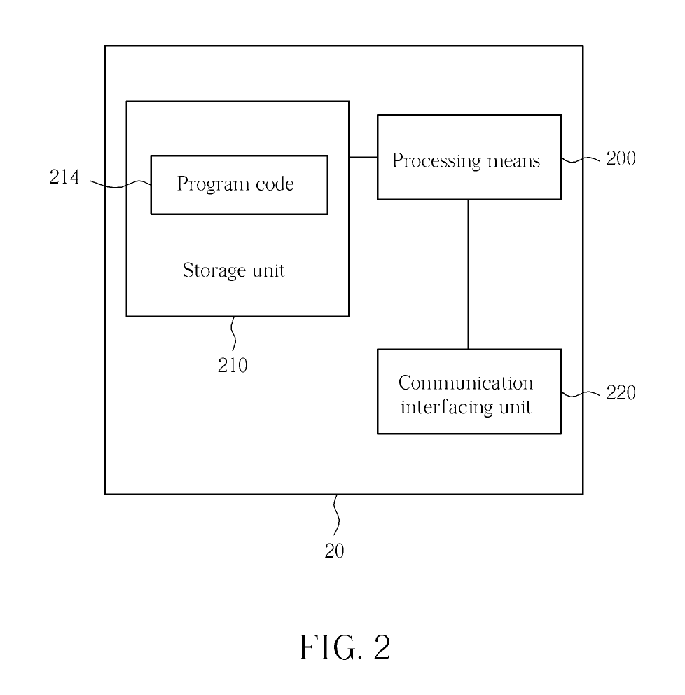

Please refer to FIG. 2, which is a schematic diagram of a communication device 20 according to an example of the present invention. The communication device 20 can be a UE or the network shown in FIG. 1, but is not limited herein. The communication device 20 may include a processing means 200 such as a microprocessor or an Application Specific Integrated Circuit (ASIC), a storage unit 210 and a communication interfacing unit 220. The storage unit 210 may be any data storage device that can store a program code 214, accessed by the processing means 200. Examples of the storage unit 210 include but are not limited to a subscriber identity module (SIM), read-only memory (ROM), flash memory, random-access memory (RAM), CD-ROM/DVD-ROM, magnetic tape, hard disk, and optical data storage device. The communication interfacing unit 220 is preferably a radio transceiver and can exchange wireless signals with the network according to processing results of the processing means 200.

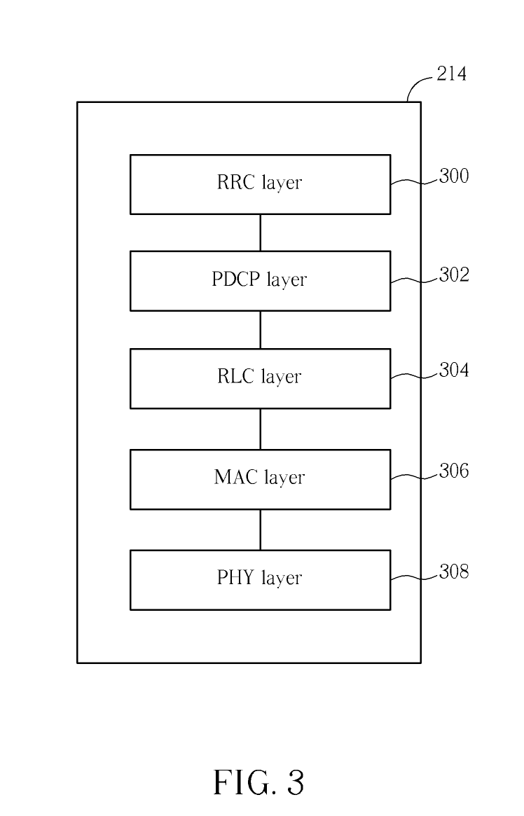

Please refer to FIG. 3, which illustrates a schematic diagram of communication protocol layers for the wireless communication system 10. The behaviors of some of the protocol layers maybe defined in the program code 214 and executed by the processing means 200. The protocol layers from top to bottom are a radio resource control (RRC) layer 300, a packet data convergence protocol (PDCP) layer 302, a radio link control (RLC) layer 304, a medium access control (MAC) layer 306 and a physical (PHY) layer 308. The RRC layer 300 is used for performing broadcast, paging, RRC connection management, measurement reporting and control and radio bearer control responsible for generating or releasing radio bearers. The PDCP layer 302 is used for ciphering and integrity protection of transmissions, and maintaining delivery order during a handover. The RLC layer 304 is used for segmentation/concatenation of packets and maintaining delivery sequence when packet loses. The MAC layer 306 is responsible for a hybrid automatic repeat request (HARQ) process, multiplexing logical channels, a random access channel (RACH) procedure and maintaining a UL timing alignment. In each HARQ process, an acknowledgement (ACK) is reported to the network if the MAC data/control packet is received and decoded successfully. Otherwise, a negative acknowledgement (NACK) is reported to the network. The PHY layer 308 is used to provide physical channels. FIG. 3 simply illustrates the behaviors of the protocol layers conceptually, and the behaviors may be different for versions of the LTE-A system.

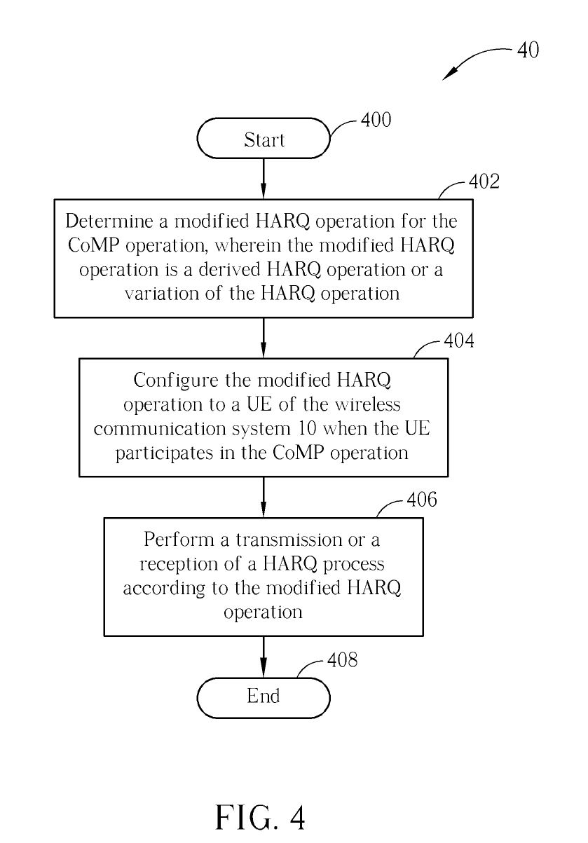

Please refer to FIG. 4, which is a flowchart of a process 40 according to an example of the present invention. The process 40 is utilized in the network shown in FIG. 1, for handling a HARQ operation. The process 40 maybe compiled into the program code 214 and includes the following steps:

Step 400: Start.

Step 402: Determine a modified HARQ operation for the CoMP operation, wherein the modified HARQ operation is a derived HARQ operation or a variation of the HARQ operation.

Step 404: Configure the modified HARQ operation to a UE of the wireless communication system 10 when the UE participates in the CoMP operation.

Step 406: Perform a transmission or a reception of a HARQ process according to the modified HARQ operation.

Step 408: End.

According to the process 40, the network (e.g. a serving cell of the UE) first determines the modified HARQ operation for the CoMP operation, wherein the modified HARQ operation is the derived HARQ operation or the variation of the HARQ operation. Further, the network configures the modified HARQ operation to the UE when the UE participates in the CoMP operation which is also configured to the UE by the network. Then, the network performs the transmission or the reception of the HARQ process (e.g. at a UL or a DL) according to the modified HARQ operation, and surely, the UE also performs the transmission or the reception of the HARQ process correspondingly. That is, the network modifies the HARQ operation for both the network and the UE, such that cooperating cells of the network have enough time to exchange necessary information required for the CoMP operation. In other words, the CoMP operation operates with complete information. Therefore, the CoMP operation can operate regularly to improve signal quality and/or avoid/mitigate the interferences.

Please note that, spirit of the process 40 is that the network (e.g. the serving cell of the UE) modifies a HARQ operation such that a coordination latency caused by exchanging necessary information required for a CoMP operation can be accommodated. Detail of realization of the process 40 is not limited. Accordingly, a UE can also perform a corresponding process with respect to the process 40. The modified HARQ operation indicates that a round-trip time (RTT) of the HARQ process for the CoMP operation is configurable, wherein the RTT can be modified as a configured RTT, is extended from a predefined RTT as an extended RTT, or is modified as a multiple of the predefined RTT. Further, the UE and/or the network can determines a timeout of the HARQ process (e.g. at a UL or a DL) according to the configured RTT, the extended RTT or the multiple of the predefined RTT, for performing the transmission or the reception of the HARQ process. Besides, the modified HARQ operation can indicate that parallel HARQ processes (e.g. according to current defined HARQ process) for consecutive transmissions or receptions (e.g. before requiring a corresponding feedback) are configurable. Further, the modified HARQ operation indicates that a number of the parallel HARQ processes for the consecutive transmissions or receptions is configurable. Thus, the UE and/or the network can perform the transmission or the reception of the HARQ process for a number of times over the number of RTTs, when the number of the parallel HARQ processes for the consecutive transmissions or receptions is configured. For example, there are HARQ processes H1-H8, and each of the HARQ processes H1-H8 can be further divided N (e.g. 3) parallel HARQ processes. For example, an HARQ process HX is divided in to parallel HARQ processes HXa, HXb and HXc, wherein each of the parallel HARQ processes can be a new transmission or a retransmission. Taking the HARQ process H5 as an example, the HARQ process H5 is divided into parallel HARQ processes H5a, H5b and H5c. If the parallel HARQ process H5a can not be properly processed (e.g. transmitted according to ACK/NACK feedback or decoded at reception), the UE or the network simply continues to process the parallel HARQ process H5b first. Besides, a feedback (e.g. of the parallel HARQ processes) corresponding to the transmission or the reception of the number of the parallel HARQ processes is accumulated until information exchange for the CoMP operation is completed. For example, if the information exchange can only be completed in 3 RTTs with cooperating cells, the UE or the network should be able to process (e.g. synchronize) accumulated parallel HARQ processes in the 3 RTTs.

On the other hand, the network can determine the modified HARQ operation according to at least one of a latency on exchanging necessary coordinated information for supporting the CoMP operation, transmission or reception modes, resource allocation or scheduling, a feedback mechanism and deployment of cooperating sites (e.g. intra eNBs or inter eNBs). The UE can be configured the modified HARQ operation according to at least one of a configuration of the CoMP operation, a configuration of transmission or reception modes, feedback configuration, a scheduling grant and a downlink (DL) assignment.

Variation of current HARQ operation (e.g. extension of RTT or parallel HARQ process for consecutive transmissions) to accommodate coordination latency: When performing CoMP HARQ, varied HARQ operation should be allowed and configurable by the network. Based on the chosen CoMP transmission mode and involving site(s), the corresponding HARQ operation (e.g. multiple RTT or number of parallel HARQ processes for consecutive transmissions) is determined and the UEs are informed of the corresponding configuration. (The latency, overall system throughput, coordination scheme, complexity and/or accumulation of exchange information are considered prior to configuration.)

Therefore, according to the above illustration and the process 40, when a CoMP operation is configured to a UE and the network including multiple cooperating cells, the cooperating cells of the network have enough time to exchange necessary information required for the CoMP operation. Therefore, the CoMP operation can operate regularly to improve signal quality and/or avoid/mitigate the interferences.

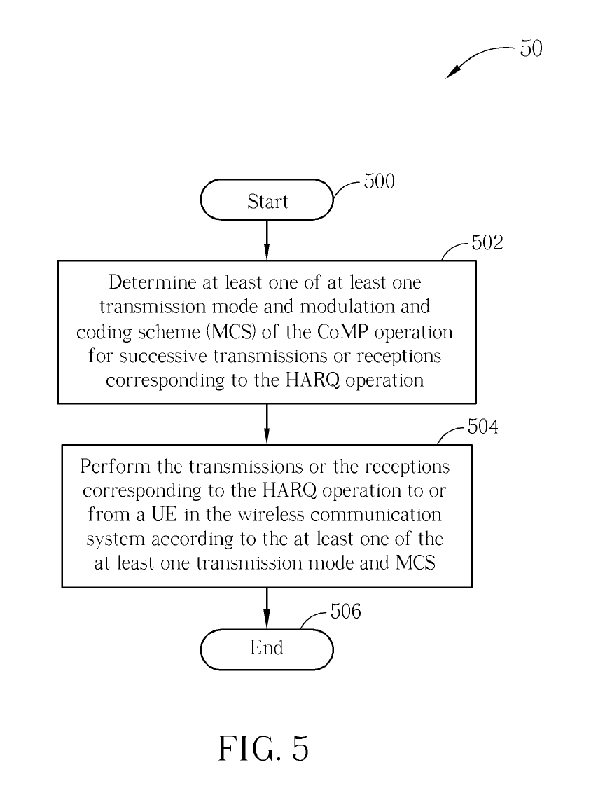

Please refer to FIG. 5, which is a flowchart of a process 50 according to an example of the present invention. The process 50 is utilized in the network shown in FIG. 1, for handling a CoMP operation. The process 50 maybe compiled into the program code 214 and includes the following steps:

Step 500: Start.

Step 502: Determine at least one of at least one transmission mode and modulation and coding scheme (MCS) of the CoMP operation for successive transmissions or receptions corresponding to the HARQ operation.

Step 504: Perform the transmissions or the receptions corresponding to the HARQ operation to or from a UE in the wireless communication system according to the at least one of the at least one transmission mode and MCS.

Step 506: End.

According to the process 50, the network first determines the at least one of the at least one transmission mode (e.g. intra-site/inter-site Joint Processing (JP) and Coordinated Scheduling/Beamforming (CS/CB)) and MCS of the CoMP operation for the successive transmissions or receptions corresponding to the HARQ operation. That is, part of successive transmissions or reception can be of a transmission mode, when the rest are of other transmission modes. Then, the network performs the transmissions or the receptions corresponding to the HARQ operation to or from the UE in the wireless communication system according to the at least one of the at least one transmission mode and MCS. That is, the network can adjust, select or switch the at least one transmission mode and MCS of the CoMP operation for the successive transmissions or receptions corresponding to the HARQ operation. In other words, transmission modes and MCSs for the successive transmissions or receptions can be different. Therefore, the CoMP can operate regularly without being affected by a coordination latency caused by exchanging necessary information between cooperating cells of the network.

Please note that, spirit of the process 50 is that the network (e.g. a serving cell of the UE) adjusts at least one of at least one transmission mode and MCS for successive transmissions or receptions such that a CoMP operation is not affected by a coordination latency caused by exchanging necessary information required for the CoMP operation. Detail of realization of the process 50 is not limited. For example, the network can determine (e.g. select or adjust) at least one of at least one transmission mode and MCS incurring less latency for earlier transmissions/receptions, and determine at least one of at least one transmission mode and MCS incurring more latency for later transmissions/receptions. That is, the at least one of the at least one transmission mode and MCS incurring less latency can be used in the earlier transmissions/receptions to meet requirement of a HARQ operation, since only part of the necessary information is exchanged (e.g. accumulated) at this time. The at least one of the at least one transmission mode and MCS incurring more latency required more time to be prepared can be used in the later transmissions/receptions, since the necessary information is exchanged (e.g. accumulated) completely at this time. Alternatively, the network can determine at least one of at least one transmission mode and MCS requiring less signalings for earlier transmissions or receptions, and determine at least one of at least one transmission mode and MCS requiring more signalings for later transmissions or receptions. That is, the at least one of the at least one transmission mode and MCS requiring less signalings can be used in the earlier transmissions/receptions to meet requirement of the HARQ operation, since only part of the signalings is received (e.g. accumulated) and processed at this time. The at least one of the at least one transmission mode and MCS requiring more signalings required more time to be prepared can be used in the later transmissions/receptions, since the signalings are received (e.g. accumulated) and processed completely at this time. On the other hand, the network can determine at least one of at least one transmission mode and MCS involving less cooperating cells for earlier transmissions or receptions, and determine at least one of at least one transmission mode and MCS involving more cooperating cells for later transmissions or receptions. That is, the at least one of the at least one transmission mode and MCS involving less cooperating cells can be used in the earlier transmissions/receptions, since only less cooperating cells can be coordinated within a small coordination latency. The at least one of the at least one transmission mode and MCS involving more cooperating cells requiring additional coordination latency to be prepared can be used in the later transmissions/receptions, since additional cooperating cells are coordinated (e.g. accumulated) at this time.

Therefore, according to the above illustration and the process 50, the CoMP operation operates adaptively to meet requirement of a HARQ operation, and does not operate with delayed or wrong information. Therefore, the CoMP operation can operate regularly to improve signal quality and/or avoid/mitigate the interferences.

Please note that, the abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 20.

To sum up, the present invention provides methods for modify a HARQ operation and adjust a CoMP operation. Therefore, the CoMP operation can operate without violating requirement of the HARQ operation. That is, either an original coordination latency is shorter than a modified RTT of the HARQ operation, or a short coordination latency is shorter than an original RTT of the HARQ operation. The CoMP operation can operate regularly to improve signal quality and/or avoid/mitigate the interferences.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling a hybrid automatic repeat request (HARQ) operation for a network in a wireless communication system, the network supporting a coordinated multipoint transmission/reception (CoMP) operation, the method comprising:
determining a modified HARQ operation for the CoMP operation, wherein the modified HARQ operation is a derived HARQ operation or a variation of the HARQ operation;
configuring the modified HARQ operation to a mobile device in the wireless communication system when the mobile device participates in the CoMP operation; and
performing a transmission or a reception of a HARQ process according to the modified HARQ operation.

2. The method of claim 1, wherein the modified HARQ operation indicates that a round-trip time (RTT) of the HARQ process for the CoMP operation is configurable.

3. The method of claim 2, wherein the RTT is modified as a configured RTT, is extended from a predefined RTT as an extended RTT, or is modified as a multiple of the predefined RTT.

4. The method of claim 3, wherein the network determines a timeout of the HARQ process according to the configured RTT, the extended RTT or the multiple of the predefined RTT, for performing the transmission or the reception of the HARQ process.

5. The method of claim 1, wherein the modified HARQ operation indicates that parallel HARQ processes for consecutive transmissions or receptions are configurable.

6. The method of claim 5, wherein the modified HARQ operation indicates that a number of the parallel HARQ processes for the consecutive transmissions or receptions is configurable.

7. The method of claim 6, wherein the network performs the transmission or the reception of the HARQ process for a number of times over the number of RTTs, when the number of the parallel HARQ processes for the consecutive transmissions or receptions is configured.

8. The method of claim 7, wherein a feedback corresponding to the transmission or the reception of the number of the parallel HARQ processes is accumulated until information exchange for the CoMP operation is completed.

9. The method of claim 1, wherein the network determines the modified HARQ operation according to at least one of a latency on exchanging necessary coordinated information for supporting the CoMP operation, transmission or reception modes, resource allocation or scheduling, a feedback mechanism and deployment of cooperating sites.

10. The method of claim 1, wherein the mobile device is configured with the modified HARQ operation by the network according to at least one of a configuration of the CoMP operation, a configuration of transmission or reception modes, feedback configuration, a scheduling grant and a downlink (DL) assignment.

11. A method of handling a hybrid automatic repeat request (HARQ) operation for a mobile device in a wireless communication system, the mobile device supporting a coordinated multipoint transmission/reception (CoMP) operation, the method comprising:
being configured with a modified HARQ operation for the CoMP operation by a network in the wireless communication system, when the mobile device participates in the CoMP operation, wherein the modified HARQ operation is a derived HARQ operation or a variation of the HARQ operation; and
performing a transmission or a reception of a HARQ process according to the modified HARQ operation.

12. The method of claim 11, wherein the modified HARQ operation indicates that a round-trip time (RTT) of the HARQ process for the CoMP operation is configurable.

13. The method of claim 12, wherein the RTT is modified as a configured RTT, is extended from a predefined RTT as an extended RTT, or is modified as a multiple of the predefined RTT.

14. The method of claim 13, wherein the mobile device determines a timeout of the HARQ process according to the configured RTT, the extended RTT or the multiple of the predefined RTT, for performing the transmission or the reception of the HARQ process.

15. The method of claim 11, wherein the modified HARQ operation indicates that parallel HARQ processes for consecutive transmissions or receptions are configurable.

16. The method of claim 15, wherein the modified HARQ operation indicates that a number of the parallel HARQ processes for the consecutive transmissions or receptions is configurable.

17. The method of claim 16, wherein the mobile device performs the transmission or the reception of the HARQ process for a number of times over the number of RTTs, when the number of the parallel HARQ processes for the consecutive transmissions or receptions is configured.

18. The method of claim 17, wherein a feedback corresponding to the transmission or the reception of the number of the parallel HARQ processes is accumulated until information exchange for the CoMP operation is completed.

19. The method of claim 11, wherein the modified HARQ operation is determined by the network according to at least one of a latency on exchanging necessary coordinated information for supporting the CoMP operation, transmission or reception modes, resource allocation or scheduling, a feedback mechanism and deployment of cooperating sites.

20. The method of claim 11, wherein the mobile device is configured with the modified HARQ operation by the network according to at least one of a configuration of the CoMP operation, a configuration of transmission or reception modes, feedback configuration, a scheduling grant and a downlink (DL) assignment.

21. A method of handling a coordinated multipoint transmission/reception (CoMP) operation for a network of a wireless communication system, the network supporting the CoMP operation, the method comprising:
determining at least one of at least one transmission mode and modulation and coding scheme (MCS) of the CoMP operation for successive transmissions or receptions corresponding to the HARQ operation; and
performing the transmissions or the receptions corresponding to the HARQ operation to or from a mobile device in the wireless communication system according to the at least one of the at least one transmission mode and MCS.

22. The method of claim 21, wherein determining the at least one of the at least one transmission mode and MCS of the CoMP operation for the successive transmissions or receptions corresponding to the HARQ operation comprises:
determining the at least one of the at least one transmission mode and MCS incurring less latency for earlier transmissions or receptions corresponding to the HARQ operation; and
determining the at least one of the at least one transmission mode and MCS incurring more latency for later transmissions or receptions corresponding to the HARQ operation.

23. The method of claim 21, wherein determining the at least one of the at least one transmission mode and MCS of the CoMP operation for the successive transmissions or receptions corresponding to the HARQ operation comprises:
determining the at least one of the at least one transmission mode and MCS requiring less signalings for earlier transmissions or receptions corresponding to the HARQ operation; and
determining the at least one of the at least one transmission mode and MCS requiring more signalings for later transmissions or receptions corresponding to the HARQ operation.

24. The method of claim 21, wherein determining the at least one of the at least one transmission mode and MCS of the CoMP operation for the successive transmissions or receptions corresponding to the HARQ operation comprises:
determining the at least one of the at least one transmission mode and MCS involving less base stations in the network for earlier transmissions or receptions; and
determining the at least one of the at least one transmission mode and MCS incurring more base stations in the network for later transmissions or receptions.
